(19) United States
(12) Patent Application Publication
(10) Pub. No.: US 2020/0023704 A1
(43) Pub. Date: Jan. 23, 2020

(54) VEHICLE SUSPENSION SYSTEM

(71) Applicant: HONDA MOTOR CO., LTD., Tokyo (JP)

(72) Inventor: Tomoya Toyohira, Wako-shi (JP)

(73) Assignee: HONDA MOTOR CO., LTD., Tokyo (JP)

(21) Appl. No.: 16/515,565

(22) Filed: Jul. 18, 2019

(30) Foreign Application Priority Data
Jul. 18, 2018 (JP) 2018-134868

(51) Int. Cl. B60G 17/015; B60G 17/019; B60G 17/0165

(52) U.S. Cl. CPC B60G 17/0152; B60G 15/02; B60G 17/0165; B60G 17/01908

(57) ABSTRACT

A suspension system includes: an electromagnetic damper 2 that is provided between a vehicle body B which is a sprung member of a vehicle and a tire T which is an unsprung member of the vehicle, and applies a damping force and a drive force in a stroke direction to the vehicle body B and the tire T by a motor; an unsprung member acceleration sensor that detects unsprung member acceleration in the stroke direction of the tire; and an ECU that controls the motor. The ECU controls the motor to generate a load Fₘ in such a direction that increases the relative velocity of the vehicle body B with respect to the tire T and of an amount corresponding to the unsprung member acceleration.

### CROSS-REFERENCE OF RELATED APPLICATION

This application claims priority of Japanese Patent Application No. 2018-134868 filed in Japan on Jul. 18, 2018, the entire contents of which are incorporated herein by reference.

### TECHNICAL FIELD

The present invention relates to a vehicle suspension system.

### BACKGROUND OF THE INVENTION

In recent years, studies and development have been made for a technique that improves comfort in riding a vehicle by providing an electromagnetic damper between a sprung member and an unsprung member of a vehicle, and controlling a drive force and a damping force generated between the sprung member and the unsprung member by the electromagnetic damper (see Japanese Patent Application Publication No. 2017-165283, for example).

For example, an electromagnetic damper described in Patent Document 1 includes an outer tube, a screw rod provided coaxially with and inside the outer tube, a nut that is screwed with the screw rod and can be displaced in the stroke direction inside the outer tube, and a motor connected with the screw rod through pulleys and a belt. In the electromagnetic damper, rotation of the motor due to extension and retraction of the electromagnetic damper induces an electromotive force, whereby a damping force is generated against the extension and retraction of the electromagnetic damper. In addition, in the electromagnetic damper, when external electric power is supplied to the motor, the screw rod rotates and generates a drive force to cause extension and retraction of the electromagnetic damper.

When the electromagnetic damper thus extends and retracts in the stroke direction, not a little frictional force is generated between the nut and the screw rod. Since the frictional force occurs in a direction that hinders the extension and retraction of the electromagnetic damper in the stroke direction, if a relatively small force acts on a tire such as when the tire rides over a slight step, for example, extension and retraction of the electromagnetic damper may be obstructed. In this case, the force acting on the tire is not damped and is directly transmitted to the vehicle body.

There is a need to provide a vehicle suspension system that can keep an impact acting on a tire from being transmitted to a vehicle body through an electromagnetic damper.

### SUMMARY OF THE INVENTION

(1) In accordance with one embodiment of the present invention, a vehicle suspension system (e.g., later-mentioned suspension system 1) includes: an electromagnetic damper (e.g., later-mentioned electromagnetic damper 2) that is provided between a sprung member (e.g., later-mentioned vehicle body B) and an unsprung member (e.g., later-mentioned tire T) of a vehicle, and applies a damping force and a drive force in a stroke direction to the sprung member and the unsprung member by an electromagnetic actuator (e.g., later-mentioned motor M); an acceleration sensor (e.g., later-mentioned unsprung member acceleration sensor 52) that detects unsprung member acceleration rate/speed in the stroke direction of the unsprung member; and a controller (e.g., later-mentioned ECU 6) that controls the electromagnetic actuator, and is characterized in that the controller controls the electromagnetic actuator to generate a load in such a direction that increases a relative velocity of the sprung member with respect to the unsprung member and of an amount/magnitude corresponding to the unsprung member acceleration.

(2) In this case, the controller preferably sets the load to 0 if the unsprung member acceleration is within a dead band width including 0.

(3) In this case, the controller preferably varies the dead band width according to vehicle speed.

(4) In this case, the controller preferably limits the load so not to exceed frictional force of the electromagnetic damper.

(5) In this case, the controller preferably varies the amount of the load according to vehicle speed.

### Effect of the Embodiments of the Invention

(1) The suspension system includes: an electromagnetic damper that applies a damping force and a drive force in a stroke direction to the sprung member and the unsprung member by an electromagnetic actuator; an acceleration sensor that detects unsprung member acceleration in the stroke direction of the unsprung member; and a controller that controls the electromagnetic actuator. The controller controls the electromagnetic actuator to generate a load in such a direction that increases a relative velocity of the sprung member with respect to the unsprung member and of an amount corresponding to the unsprung member acceleration. With this, when unsprung member acceleration is increased by the unsprung member overriding a step, for example, a load of a size corresponding to the unsprung member acceleration is generated in such a direction that increases the relative velocity, that is, a direction that reduces the frictional force of the electromagnetic damper. Hence, according to the suspension system of the present invention, the characteristic of the frictional force can be made equivalent to that of a smaller than actual electromagnetic damper. Accordingly, even when an impact acts on the unsprung member, the impact can be kept from being transmitted to the sprung member.

(2) The controller sets the load to 0 if the unsprung member acceleration is within a dead band width including 0. According to the suspension system of the present invention, by providing such a dead band for unsprung member acceleration, it is possible to prevent generation of load in the electromagnetic damper due to noise in the acceleration sensor or micro vibration of the unsprung member, for example. Hence, comfort in riding the vehicle can be improved.

(3) The controller varies the dead band width according to vehicle speed. Hence, the area in which to generate a load in an amount corresponding to unsprung member acceleration can be varied according to vehicle speed. This can improve comfort in riding the vehicle even more.

(4) If a load larger than frictional force is generated in the electromagnetic damper, juddering of the unsprung member may increase. Hence, in the suspension system, the load is limited so not to exceed frictional force of the electromagnetic damper. This can suppress juddering of the unsprung member.

(5) The controller varies the amount of the load according to vehicle speed. Hence, it is possible to generate an appropriate load amount corresponding to vehicle speed.

### BRIEF DESCRIPTION OF THE DRAWINGS

FIG. 1 is a diagram showing a configuration of a vehicle suspension system of an embodiment of the present invention.

FIG. 2 is a diagram showing a machine model of a suspension system 1.

FIG. 3 is a diagram showing a characteristic of frictional force relative to change in a stroke amount.

FIG. 4 is a functional block diagram showing a specific procedure of calculating a target load in a target load calculator.

FIG. 5 is a time chart showing an example of how an electromagnetic damper is controlled by an ECU.

### DETAILED DESCRIPTION OF EMBODIMENTS OF THE INVENTION

Hereinafter, an embodiment of the present invention will be described with reference to the drawings.

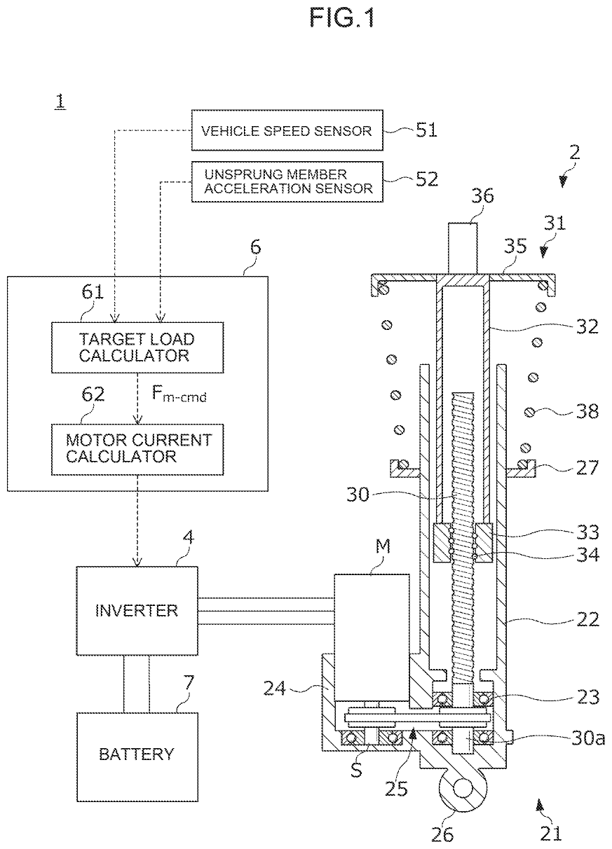

FIG. 1 is a diagram showing a configuration of a vehicle suspension system 1 of the embodiment. The vehicle is a four-wheel vehicle including four tires, for example, and one suspension system 1 is provided for each tire. FIG. 1 shows only one of the four suspension systems 1.

The suspension system 1 includes an electromagnetic damper 2, various sensors 51, 52 that detect states of the vehicle, an electronic control unit 6 (hereinafter abbreviated as “ECU (Electronic Control Unit) 6” that controls the electromagnetic damper 2 by using detected signals of the sensors 51, 52, and a battery 7.

The electromagnetic damper 2 includes a damper main body 20 provided between a vehicle body B which is a sprung member of the vehicle and a tire which is an unsprung member of the vehicle, a motor M as an electromagnetic actuator provided in the damper main body 20, and an inverter 4 that supplies electric power supplied from the battery 7 to the motor M.

The damper main body 20 includes an outer tube member 21, a screw rod 30 provided inside the outer tube member 21, an inner tube member 31 having one end inserted into the outer tube member 21, and a spring 38 provided between the outer tube member 21 and the inner tube member 31.

The outer tube member 21 includes a cylindrical outer tube 22 that pivotally supports the screw rod 30 therein in a rotatable manner, a motor supporting portion 24 that is provided in an outer peripheral portion of the outer tube 22 and supports the motor M, and a power transmission member 25 that transmits power generated in an output shaft S of the motor M to the screw rod 30. A bearing 23 that rotatably supports a base end portion 30a of the screw rod 30 is provided inside the base end side of the outer tube 22. An unsprung member connector 26 is provided in an outer portion of the base end side of the outer tube 22. Additionally, a flange-shaped spring seat portion 27 that extends perpendicular to the axis of the screw rod 30 is provided in an outer peripheral portion of the tip end side of the outer tube 22. The power transmission member 25 includes a first pulley provided in the output shaft S of the motor M, a second pulley provided in the base end portion 30a of the screw rod 30, and an endless belt wound around the first pulley and the second pulley.

The inner tube member 31 includes a cylindrical inner tube 32 having a portion on the tip end side inserted into the outer tube 22, and a nut 33 provided on the tip end side of the inner tube 32. A spiral screw groove that receives multiple balls 34 is formed on an outer peripheral surface of the screw rod 30. The nut 33 is screwed onto the screw rod 30 through the balls 34. Accordingly, the screw rod 30, the nut 33, and the balls 34 form a ball screw. As a result, the outer tube member 21 and the inner tube member 31 can be relatively displaced in the stroke direction. A sprung member connector 35 is provided in an outer portion of the base end side of the inner tube 32. Additionally, a flange-shaped spring seat portion 36 that extends perpendicular to the axis is provided in an outer peripheral portion of the base end side of the inner tube 32.

The spring 38 is a compression coil spring, for example, and is interposed between the spring seat portion 27 of the outer tube member 21 and the spring seat portion 36 of the inner tube member 31 in a compressed state. Accordingly, the outer tube member 21 and the inner tube member 31 are energized away from each other by the spring 38.

The motor M is a three-phase brushless motor, for example. The output shaft S of the motor M is connected to the screw rod 30 through the power transmission member 25. The inverter 4 converts DC power supplied from the battery 7 into AC power according to a motor current instruction signal transmitted from the ECU 6 and supplies it to the motor M, and converts AC power supplied from the motor M into DC power and supplies it to the battery 7.

The vehicle body which is the sprung member is connected to the sprung member connector 35 of the inner tube member 31. The tire which is the unsprung member is connected to the unsprung member connector 26 of the outer tube member 21 through an unillustrated suspension arm.

The electromagnetic damper 2 described above acts in the following manner.

First, when the outer tube member 21 and the inner tube member 31 are relatively displaced in the stroke direction, the screw rod 30 and the nut 33 are relatively displaced in the stroke direction, whereby the screw rod 30 is rotated. Rotation of the screw rod 30 is transmitted to the output shaft S of the motor M through the power transmission member 25, so that the output shaft S rotates. Similarly, when the motor M rotates, the outer tube member 21 and the inner tube member 31 are relatively displaced in the stroke direction. Thus, the relative displacement in the stroke direction of the outer tube member 21 and the inner tube member 31, that is, the extension and retraction of the electromagnetic damper 2 are linked with rotation of the motor M. When the output shaft S of the motor M rotates by the extension and retraction of the electromagnetic damper 2, an electromotive force is induced and generates a rotational resistance corresponding to the induced electromotive force, whereby a damping force against the extension and retraction of the electromagnetic damper 2 is generated. Meanwhile, when the output shaft S of the motor M is rotated by electric power supplied from the battery 7, the electromagnetic damper 2 extends and retracts by generating a drive force to the extension side and the retraction side in the stroke direction. The drive force and the damping force generated in the electromagnetic damper 2 and applied to the vehicle body and the tire are controlled by exchange of electric power between the motor M and the inverter 4.

The vehicle speed sensor 51 detects vehicle speed which is the speed of the vehicle, and transmits a signal according to the detected value to the ECU 6. The unsprung member acceleration sensor 52 is provided in the tire which is the unsprung member, detects unsprung member acceleration which is acceleration of the tire in the stroke direction of the electromagnetic damper 2, and transmits a signal according to the detected value to the ECU 6.

The ECU 6 is an onboard computer formed of a CPU, a ROM, a RAM, a data bus, an input-output interface, and other components. The ECU 6 performs various calculation processing in the CPU according to a program stored in the ROM, to thereby function as a target load calculator 61 and a motor current calculator 62 described below.

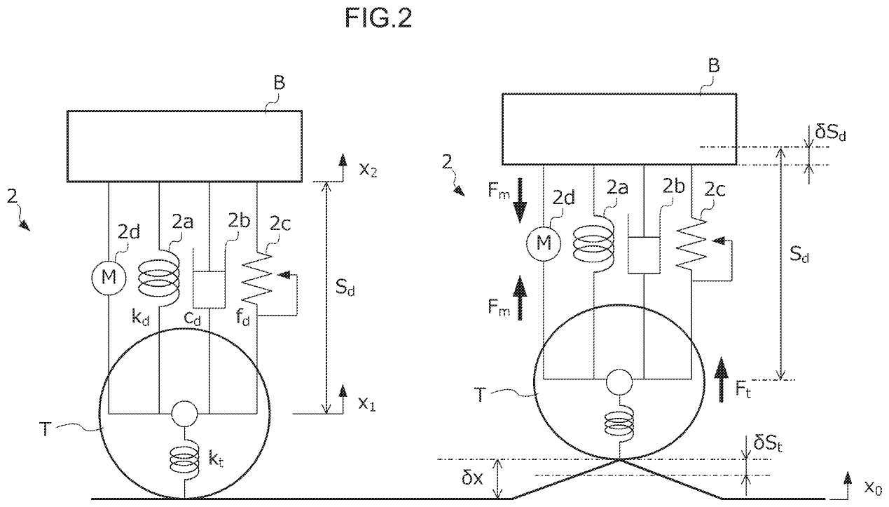

The target load calculator 61 calculates a target load which is a target of a load generated by the motor M in the electromagnetic damper 2 based on the detected signal of various sensors such as the vehicle speed sensor 51 and the unsprung member acceleration sensor 52. A specific procedure of calculating a target load in the target load calculator 61 will be described with reference to FIGS. 2 to 4.

FIG. 2 is a diagram showing a machine model of the suspension system 1.

The suspension system 1 including a tire T which is the unsprung member and the vehicle body B which is the sprung member connected by the electromagnetic damper 2, is expressed as a two-degree-of-freedom vibration system shown in FIG. 2. In addition, the electromagnetic damper 2 is expressed as a system in which a spring element 2a characterized by a spring coefficient k_{d}, a damper element 2b characterized by a viscous damping coefficient c_{d}, a friction element 2c characterized by a friction coefficient f_{d}, and a motor element 2d generating a load corresponding to the target load, are connected in parallel. The tire T is expressed as a spring element Ta characterized by a spring coefficient kₜ.

Equations of motion of the two-degree-of-freedom vibration system shown in FIG. 2 are expressed by the following equations (1-1) and (1-2) when displacement of the tire T from a predetermined reference position is “x₁,” displacement of the vehicle body B from a predetermined reference position is “x₂, ” mass of the tire T is “m₁,” mass of the vehicle body B is “m₂,” the position of a road surface L is “x₀,” and the load generated by the motor element 2d is “Fₘ.” Note that in the following equations (1-1) and (1-2), values obtained by differentiating the displacements x₁, x₂ with time, that is, the absolute velocity of the tire T and the vehicle body B are indicated by the displacements x₁, x₂ with one dot. Further, values obtained by differentiating the absolute velocity with time, that is, acceleration of the tire T and the vehicle body B are indicated by the displacements x₁, x₂ with two dots. Note that in the following description, a velocity obtained by subtracting the absolute velocity of the vehicle body B from the absolute velocity of the tire T is also referred to as a relative velocity of the vehicle body B with respect to the tire T. In addition, in the following description, acceleration of the tire T is also referred to as unsprung member acceleration.

[Expression 1]

m₂·\ddot{x}₂=k_{d}·(x₁−x₂)+c_{d}·(\dot{x}₁−\dot{x}₂)+f_{d}·(\dot{x}₁−\dot{x}₂)−Fₘ (1-1)

m₁·\ddot{x}₁=k_{d}·(x₂−x₁)+c_{d}·(\dot{x}₂−\dot{x}₁)+k₁·(x₀−x₁)+f_{d}·(\dot{x}₂−\dot{x}₁)+Fₘ (1-2)

Here, a case where the tire T rides over a step with a height δx will be considered. In this case, deflection with a displacement δSₜ corresponding to the height δx occurs in the tire T, so that an elastic force Fₜ indicated by the following equation (2) acts on the tire T.

[Expression 2]

F₁=kₗ×δSₜ (2)

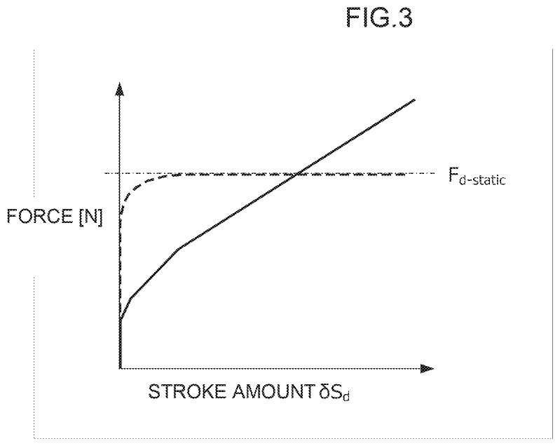

Additionally, when a reference space which is the space between the reference position of the tire T and the reference position of the vehicle body B is “S_{d}” and displacement of the space between the tire T and the vehicle body B from the aforementioned reference space S_{d}, that is, the stroke amount of the electromagnetic damper 2 is “δS_{d},” a frictional force F_{d} which is a term proportional to the friction coefficient f_{d} in the equations of motion (1-1) and (1-2) is considered to occur in an infinitesimal stroke amount δS_{d} and become saturated at a predetermined value F_{d-static}, as indicated by a broken line in FIG. 3. Hence, if the aforementioned elastic force Fₜ acting on the tire T is smaller than the frictional force F_{d}, the stroke amount δS_{d} is substantially 0. As a result, an acceleration proportional to the elastic force Fₜ in the stroke direction occurs in the vehicle body B.

For this reason, the target load calculator 61 calculates the target load such that the motor element 2d generates a load Fₘ proportional to the unsprung member acceleration obtained by the unsprung member acceleration sensor 52, as indicated by the following equation (3). More specifically, as indicated by the following equation (3), the target load calculator 61 calculates the target load so as to generate the load Fₘ in such a direction that increases the relative velocity of the vehicle body B with respect to the tire T and in such an amount corresponding to unsprung member acceleration. Since the motor element 2d generates the load Fₘ as indicated by the following equation (3), the characteristic of the frictional force generated in the electromagnetic damper 2 can be made linear with respect to the stroke amount δS_{d}, as indicated by the solid line in FIG. 3. That is, by generating the load Fₘ as indicated by the following equation (3), the characteristic of the frictional force can be made equivalent to that of a smaller than actual electromagnetic damper. Hence, even when an impact described above acts on the tire T, the impact can be kept from being transmitted to the vehicle body B.

[Expression 3]

Fₘ=G_{A}·\ddot{x}₁ (3)

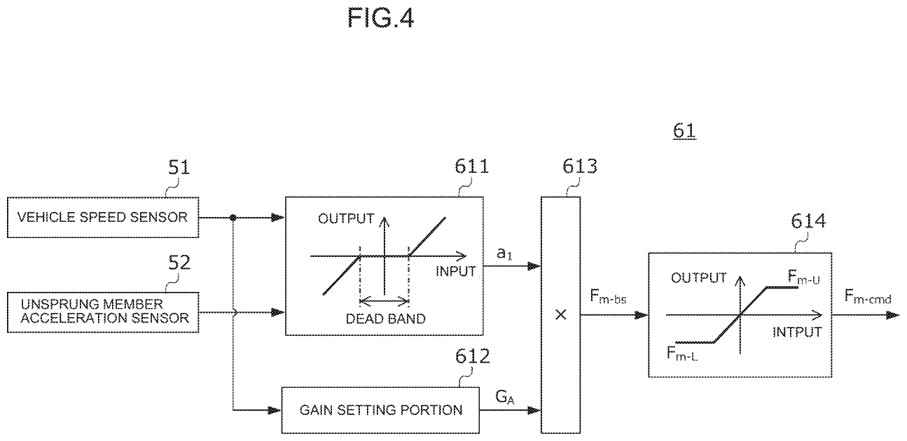

FIG. 4 is a functional block diagram showing a specific procedure of calculating a target load in the target load calculator 61. The target load calculator 61 uses a dead band filter 611, a gain setting portion 612, a multiplier 613, and a limiter 614 to calculate a target load F_{m-cmd} which is a target of the load Fₘ.

The dead band filter 611 performs dead band filter processing on a detected signal of the unsprung member acceleration sensor 52. More specifically, the dead band filter 611 outputs value 0 if the detected value of unsprung member acceleration obtained by the unsprung member acceleration sensor 52 is within a predetermined dead band width including 0, and outputs the detected value directly if the detected value of unsprung member acceleration is out of the dead band width. Hereinafter, the value of unsprung member acceleration obtained through the dead band filter processing by the dead band filter 611 is denoted as “a₁.”

Note that the dead band filter 611 varies such a dead band width according to the vehicle speed detected by the vehicle speed sensor 51. More specifically, the dead band filter 611 narrows the dead band width for a higher vehicle speed, for example.

The gain setting portion 612 sets a positive gain G_{A} corresponding to a ratio between the unsprung member acceleration a₁ and the target load F_{m-cmd}. The gain setting portion 612 varies the value of the gain G_{A} according to the vehicle speed detected by the vehicle speed sensor 51, so that the target load F_{m-cmd} varies according to the vehicle speed. More specifically, the gain setting portion 612 increases the value of the gain G_{A} for a higher vehicle speed, for example.

The multiplier 613 calculates a basic value F_{m-bs} of the target load, by multiplying the unsprung member acceleration a₁ obtained through the dead band filter 611 by the gain G_{A} set by the gain setting portion 612, as indicated by the following equation (4).

[Expression 4]

F_{m-bs}=G_{A}·α₁ (4)

The limiter 614 calculates the target load F_{m-cmd} by performing limit processing on the basic value F_{m-bs} of the target load obtained by the multiplier 613. As indicated by the above equation (4), the basic value F_{m-bs} of the target load is proportional to acceleration of the tire T in the stroke direction. Hence, if the basic value F_{m-bs} obtained by the multiplier 613 is used directly, when a large impact acts on the tire T in the stroke direction, for example, the load generated by the electromagnetic damper 2 largely exceeds the frictional force F_{d}. This causes the tire T to judder, whereby stable driving of the vehicle may be hindered.

For this reason, the limiter 614 calculates the target load F_{m-cmd} by limiting the basic value F_{m-bs} of the target load calculated by the multiplier 613, so that the load Fₘ generated by the electromagnetic damper 2 does not exceed the frictional force F_{d}. More specifically, the limiter 614 sets the basic value F_{m-bs} calculated by the multiplier 613 directly as the target load (F_{m-cmd}=F_{m-bs}) if the basic value is equal to or smaller than a predetermined positive upper limit value F_{m-U} and equal to or larger than a negative lower limit value F_{m-L}, sets the upper limit value F_{m-U} as the target load (F_{m-cmd}=F_{m-U}) if the basic value F_{m-bs} is larger than the upper limit value, and sets the lower limit value F_{m-L} as the target load (F_{m-cmd}=F_{m-L}) if the basic value F_{m-bs} is smaller than the lower limit value.

Referring back to FIG. 1, the motor current calculator 62 generates a motor current instruction signal corresponding to a target of the current supplied to the motor M such that the electromagnetic damper 2 achieves the target load F_{m-cmd} calculated by the target load calculator 61, and inputs the motor current instruction signal to the inverter 4. With this, a current corresponding to the motor current instruction signal is supplied to the motor M, and the motor M generates a load corresponding to the target load F_{m-cmd} and applies the load to the unsprung member and the sprung member.

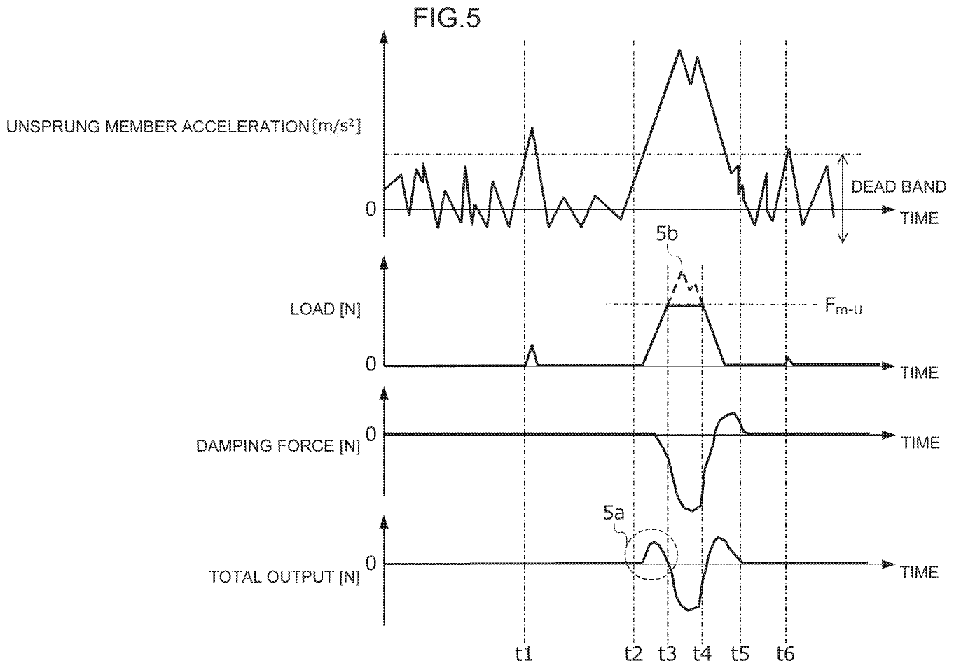

FIG. 5 is a time chart showing an example of how the electromagnetic damper 2 is controlled by the ECU 6. FIG. 5 shows unsprung member acceleration [m/s²] detected by the unsprung member acceleration sensor 52, the load [N] generated by the motor M in the electromagnetic damper 2, the damping force [N] proportional to the relative velocity, and the output [N] of the electromagnetic damper 2 as a result of combining the load and the damping force, in this order from upper to lower parts of FIG. 5. FIG. 5 shows an example of how the electromagnetic damper 2 is controlled when the tire T rides over a step as shown in FIG. 2 during time t2 to t5.

As shown in FIG. 5, unsprung member acceleration fluctuates slightly even at times other than the time t2 to t5 when the tire T rides over the step, due to noise in the unsprung member acceleration sensor 52 or a slight unevenness of the road surface. For this reason, the ECU 6 calculates a target load by use of the unsprung member acceleration obtained by performing dead band filter processing on the detected signal of the unsprung member acceleration sensor 52. Accordingly, the load generated by the motor M is 0 while the detected value of the unsprung member acceleration sensor 52 is within the dead band width, and is generated only at time t1, t2 to t5, and t6, for example, when the detected value of the unsprung member acceleration sensor 52 exceeds the dead band width.

When the tire T rides over a step during time t2 to t5, unsprung member acceleration increases, as shown in FIG. 5. The ECU 6 calculates the target load of the electromagnetic damper 2, by multiplying the unsprung member acceleration obtained by performing dead band filter processing on the detected signal of the unsprung member acceleration sensor 52 by a predetermined gain. This generates a load in such a direction that increases the relative velocity, that is, a direction opposite to the damping force, and of an amount proportional to the unsprung member acceleration during time t2 to t5, as shown in FIG. 5. At time t2 immediately after the tire T rides over the step, since frictional force occurs in a direction that hinders extension and retraction of the electromagnetic damper 2, the electromagnetic damper 2 hardly extends and retracts in the stroke direction. Hence, the ECU 6 generates a load proportional to the unsprung member acceleration by use of the motor M, and can thereby add an assistive force for prompting extension and retraction of the electromagnetic damper 2 against frictional force, as indicated by a broken line 5a.

Additionally, when the load of an amount proportional to unsprung member acceleration is generated in this manner, if the unsprung member acceleration varies largely during time t3 to t4, the load generated by the motor M exceeds the frictional force and may cause more juddering of the tire T. Hence, the ECU 6 performs limit processing to limit the target load F_{m-cmd} to a range between the predetermined upper limit value F_{m-U} and lower limit value F_{m-L}, and can thereby prevent generation of a load that exceeds the frictional force as indicated by a broken line 5b in FIG. 5.

The suspension system 1 of the embodiment exerts the following effects.

(1) The ECU 6 controls the motor M to generate a load in such a direction that increases the relative velocity of the vehicle body B with respect to the tire T and in such an amount corresponding to unsprung member acceleration. With this, when unsprung member acceleration is increased by the tire T overriding a step, for example, the load in the amount corresponding to the unsprung member acceleration is generated in such a direction that increases the relative velocity, that is, a direction that reduces the frictional force of the electromagnetic damper 2. Hence, according to the suspension system 1, the characteristic of the frictional force can be made equivalent to that of a smaller than actual electromagnetic damper. Accordingly, even when an impact acts on the tire T, the impact can be kept from being transmitted to the vehicle body B.

(2) The ECU 6 sets the load to 0 if unsprung member acceleration is within a dead band width including 0. According to the suspension system 1, by providing such a dead band for unsprung member acceleration, it is possible to prevent generation of load in the electromagnetic damper 2 due to noise in the unsprung member acceleration sensor 52 or micro vibration of the tire T, for example. Hence, comfort in riding the vehicle can be improved.

(3) The ECU 6 varies the dead band width according to vehicle speed. Hence, the area in which to generate a load of in an amount corresponding to unsprung member acceleration can be varied according to vehicle speed. This can improve comfort in riding the vehicle even more.

(4) In the suspension system 1, a load is limited so not to exceed frictional force of the electromagnetic damper 2. This can suppress juddering of the tire T.

(5) The ECU 6 varies the amount of a load according to vehicle speed. Hence, it is possible to generate an appropriate amount of the load corresponding to vehicle speed.

While an embodiment of the present invention has been described, the invention is not limited to this. Detailed configurations may be changed appropriately within the gist of the invention.

1. A vehicle suspension system for a vehicle, comprising:
an electromagnetic damper provided with an electromagnetic actuator and provided between a sprung member and an unsprung member of the vehicle, the electromagnetic actuator generating a load such that a damping force and a drive force are applied in a stroke direction of the electromagnetic damper to the sprung member and the unsprung member;
an acceleration sensor configured to detect acceleration of the unsprung member in the stroke direction; and
a controller configured to control the electromagnetic actuator such that the load is generated in such direction that increases a relative velocity of the sprung member with respect to the unsprung member and in such amount that accords to the acceleration of the unsprung member detected by the acceleration sensor.

2. The vehicle suspension system according to claim 1, wherein
the controller is further configured to set the load to 0 when the acceleration of the unsprung member is within a dead band width including 0.

3. The vehicle suspension system according to claim 2, wherein
the controller is further configured to vary the dead band width according to a speed of the vehicle.

4. The vehicle suspension system according to claim 1, wherein
the controller is further configured to limit the load so not to exceed frictional force of the electromagnetic damper.

5. The vehicle suspension system according to claim 1, wherein
the controller is further configured to vary the amount of the load according to a speed of the vehicle.
